(19) United States
(12) Patent Application Publication
(10) Pub. No.: US 2002/0150247 A1
(43) Pub. Date: Oct. 17, 2002

(54) Watermark embedding

(76) Inventors: Johan Paul Marie Gerard Linnartz, Eindhoven (NL); Johan Cornelis Talstra, Eindhoven (NL)

Correspondence Address: U.S. Philips Corporation, 580 White Plains Road, Tarrytown, NY, 10591, US

(21) Appl. No.: 10/118,877

(22) Filed: Apr. 9, 2002

(30) Foreign Application Priority Data
Apr. 12, 2001 (EP) 01201346.2

(51) Int. Cl. H04K 1/02

(52) U.S. Cl. 380/205; 380/252

(57) ABSTRACT

The invention relates to a watermark embedding method and to transcoding and digital recording apparatus including a facility for watermark embedding. A first embodiment incorporates a watermark embedding system with a cascaded decoder/encoder transcoder of the type commonly found in digital recording apparatuses. An input data stream in a first format is received by a decoder (10) of the transcoder. Coding parameters are fed from a first output of the decoder (10) to a first input of an encoder (30) of the transcoder. A second output of the decoder (10) comprises a baseband video signal which is passed to a first input of an adder (24). An output of a watermark generator (22) is fed to a second input of the adder (24). An output of the adder (24) is fed to a second input of the encoder 30. The output of the encoder (30) comprises the information to be recorded in a second format which is compatible with a storage medium.

The present invention relates to an apparatus, a digital recording apparatus and a method, in particular including a facility for watermark embedding.

Embedding a watermark in digital video or audio data comprises the incorporation of recoverable messages into data, preferably in a manner that produces imperceptible alterations to the representation of the data presented by a video or audio output device. For example, a watermark may manifest itself in the representation of the data presented by a video output device as small pseudo-random variations in the luminance of the picture. The process of embedding a watermark is known as watermarking. A simple practical implementation of such a watermark embedder can use a predefined two-dimensional watermark pattern, containing +1 and −1 values. The embedder adds each value of the watermark to the luminance value of the corresponding pixel in the image, i.e., it increases or decreases the luminance of the original image by a single quantization step, according to the watermark pattern. Many other watermarking schemes have been proposed in the technical literature. For instance, all addition operations can be executed in the DCT or FFT transform domain. In order to allow optimum detectability of the watermark by an electronic device but to ensure imperceptibility to the human eye or ear, the embedding is usually done taking into account the perceptual masking properties of the audio or video signal. The watermark is embedded strongly (e.g. more than a single quantization step) in areas where the human audio/visual perception abilities are less sensitive to modifications. On the other hand, the embedding may be done weakly or not at all in areas where the human observation is sensitive to modifications. Often the watermark pattern is kept secret and not disclosed in public.

Watermarking can be used to provide information about the source of the data or the copyright status of the data. One usefull functionality enabled by digital watermarks is the ability to notify digital recording equipment of the copyright status of data. If the digital watermark indicates that data is protected by copyright, the digital recording equipment can refuse to produce an unauthorised copy. This functionality can be extended by the use of watermarks indicating first generation copies which are allowed to be copied once, with the copied data then being re-marked with a further watermark (or by a replacement watermark) indicating the second generation status of the data. Digital recording equipment can interpret the re-marked data and refuse to make further copies. Such a scheme could be of use for allowing single backup copies of data to be made, or when recording broadcast signals, with the watermark of the original indicating “copy-once” status and the watermarks in the re-marked data indicating “copy-no-more” status.

Some commonly used methods of watermarking are described in the following paper by I. J. Cox, M. Miller, J. P. M. G. Linnartz and A. C. C. Kalker, entitled “A review of watermarking principles and practices”, which appears in Chapter 17 of “Digital Signal Processing for Multimedia Systems”, K. K. Parhi and T. Nishitani (eds.), Marcel Dekker, Inc., New York, March 1999, pp. 461-486.

A problem with the re-marking of digital data in digital recording equipment, especially in relation to digital recording equipment for domestic use, is the complicated nature of watermarking processes. Particular problems can occur in the watermarking of digital data coded in an MPEG scheme, because the MPEG bit-stream syntax must be maintained to prevent harmful buffer underflows/overflows. These problems can be overcome but by an increase in the complexity of the watermark embedding system.

The full decoding of an MPEG bit-stream to allow the watermark to be inserted into the perceived video information avoids the buffer underflow/overflow problem and gives more flexibility over the perceptibility of the watermark in the representation of the data presented by an output device. However, the decompression involved in full decoding is computationally intensive and it is very likely that intensive recompression will be needed to reduce the amount of data stored after the re-marking has taken place. Such decompression and recompression is not suitable for basic recorders due to the costs introduced by the inclusion of the decompression and recompression systems needed by the watermark embedding system. Decompression and subsequent recompression also tends to introduce extra quantization noise, especially so if done using a consumer-grade compressions system.

It is an aim of preferred embodiments of the present invention to provide an apparatus, digital recording apparatus and a method that overcomes or reduces to a certain extent at least one of the problems described above. It is a further aim of embodiments of the invention to provide such a method and apparatus which obviates the need for introduction of additional complex decompression and recompression systems as required by certain prior art methods and which is suitable for use in domestic digital recording equipment.

It is a particular aim of embodiments of the invention to provide transcoding apparatus, a digital recording apparatus and a method in which the complexity of watermarking is reduced by embedding a watermark during a transcoding operation, in which such a transcoding operation is an operation which is already required to provide a necessary format conversion.

According to a first aspect of the invention there is provided a transcoding apparatus comprising: a transcoder for converting an input data stream containing information in a first format into a second format; and a watermark embedding device for embedding a watermark within an output data stream, the apparatus being characterised in that the watermark embedding device is arranged to receive first data from a first part of the transcoder and to provide watermarked data to a second part of the transcoder.

Apparatus as described above permits the incorporation of a watermark embedding system that does not require the introduction of additional complex decompression and recompression systems, instead advantages are taken of the partial decoding and recoding which are in any event necessary when converting from one format to another.

Preferably, the watermark embedding device is arranged to mark the output data stream to reflect a desired status of the information to be recorded. The desired status is preferably a copy status of the information to be recorded.

Preferably, the first part of the transcoder comprises decoding means for at least partially decoding the input data stream containing information in the first format.

Preferably, the second part of the transcoder comprises encoding means for converting to the second format.

The first and second formats may be essentially the same, but may have different compression parameters, such as different bit rates.

Preferably, the second format is a recording format having a reduced bit rate as compared to the first format.

The first format may be an MPEG coding scheme.

In particular, the first format may be encoded in an MPEG-2 transport stream (TS) format.

The second format may be a program stream format. More specifically, the second format is preferably an MPEG-2 Program Stream (PS) format.

Alternatively, the first format may be a Transport Stream (TS) format and the second format may be a real time rewriteable (RTRW) format.

Preferably, the information to be recorded comprises video or audio information.

Preferably, the storage medium comprises a disc, hard disk, solid state memory, or a tape.

Preferably, the watermark embedding device and transcoder share a common syntax management system.

Preferably, the transcoder for converting an incoming data stream and the watermark embedding device share a common syntax management system relating to the second format compatible with the storage medium.

The transcoder preferably comprises a cascaded decoder and encoder.

The transcoding system may comprise a motion compensated bit rate transcoder.

The transcoding system may comprise a discrete cosine transform coefficient requantisation bit rate transcoder.

The transcoding system may comprise a discrete cosine transform coefficient damping bit rate transcoder.

The invention includes digital recording apparatus comprising the transcoding apparatus.

According to a second aspect of the invention, there is provided a method of embedding a watermark within information of a received data stream, the method comprising: receiving an input data stream containing information in a first format and decoding data from said first format to provide decoded data; embedding the watermark into the decoded data to provide decoded watermarked data; and encoding the decoded watermarked data into a second format.

Preferably, coding parameters from the input data stream are utilised to adapt the watermark to the content in which it is to be embedded.

The method of the second aspect may contain any of the features or limitations of the apparatus of the first aspect in any logical combination.

For a better understanding of the invention, and to show how embodiments of the same may be carried into effect, reference will now be made, by way of example, to the accompanying diagrammatic drawings in which:

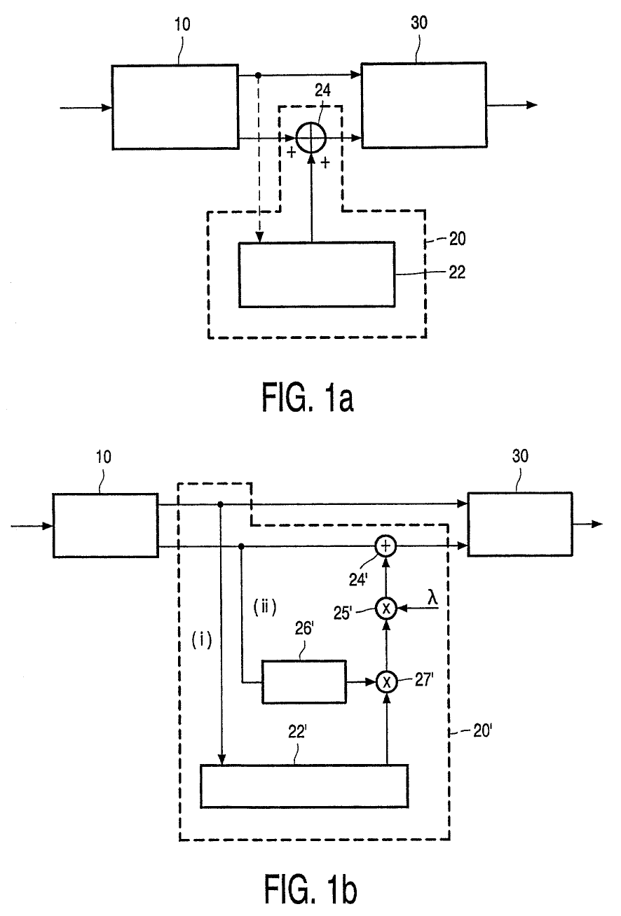

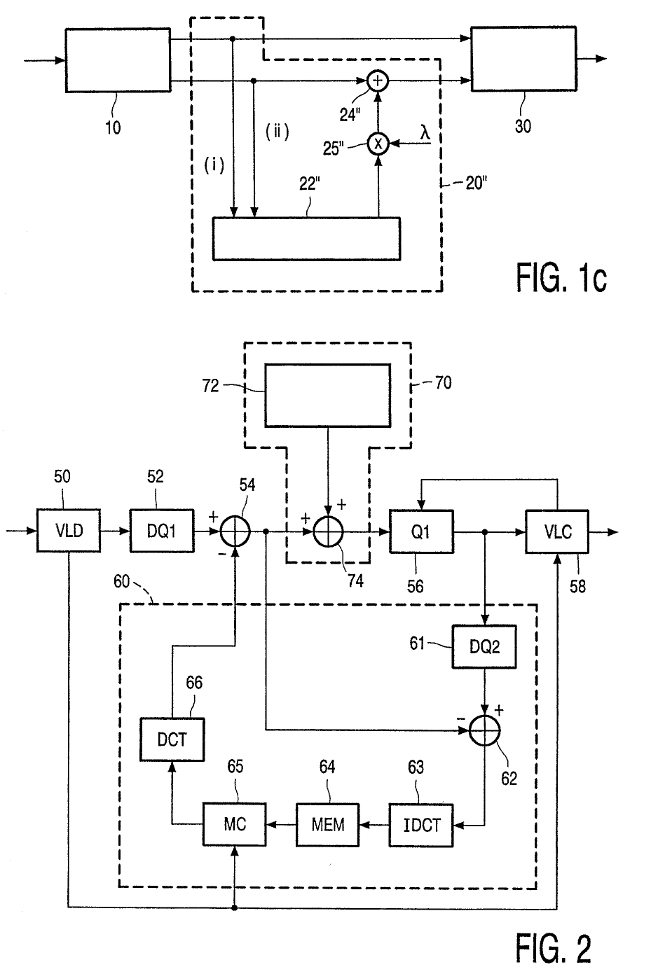

FIG. 1a shows a block diagram representing a section of a digital recording apparatus according to a first embodiment of the invention in which transcoding is carried out by a cascaded decoder and encoder;

FIGS. 1b and 1c show alternative arrangements of watermark embedder;

FIG. 2 shows a block diagram representing a section of a digital recording apparatus according to a second embodiment of the invention in which transcoding is carried out by a motion compensated bit rate transcoder;

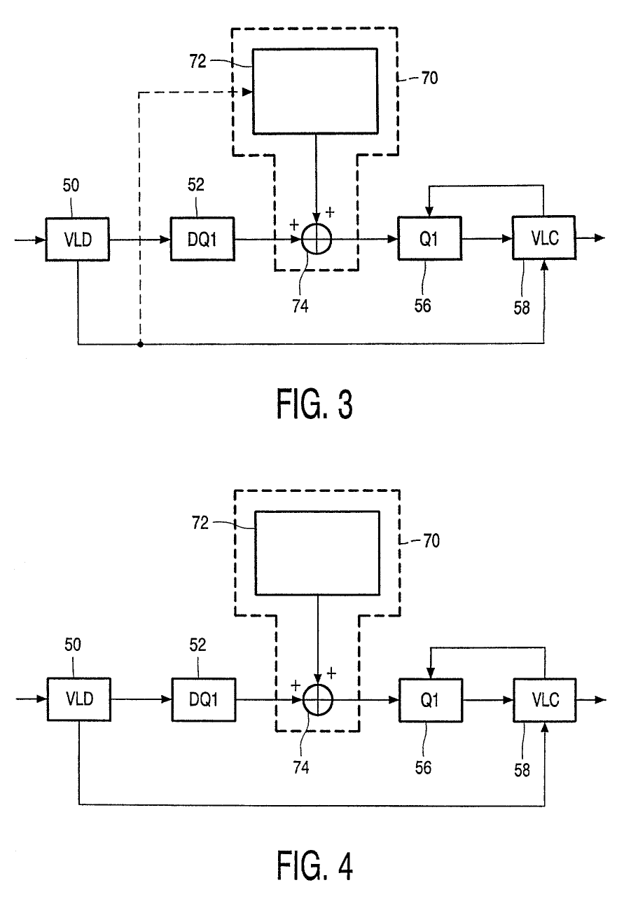

FIG. 3 shows a block diagram representing a section of a digital recording apparatus according to a third embodiment of the invention in which transcoding is carried out by a bit-rate transcoder;

FIG. 4 shows a block diagram representing a section of a digital recording apparatus according to a fourth embodiment of the invention in which a watermark embedder is combined with a bit rate transcoder in which high order discrete cosine transform (DCT) coefficients are damped;

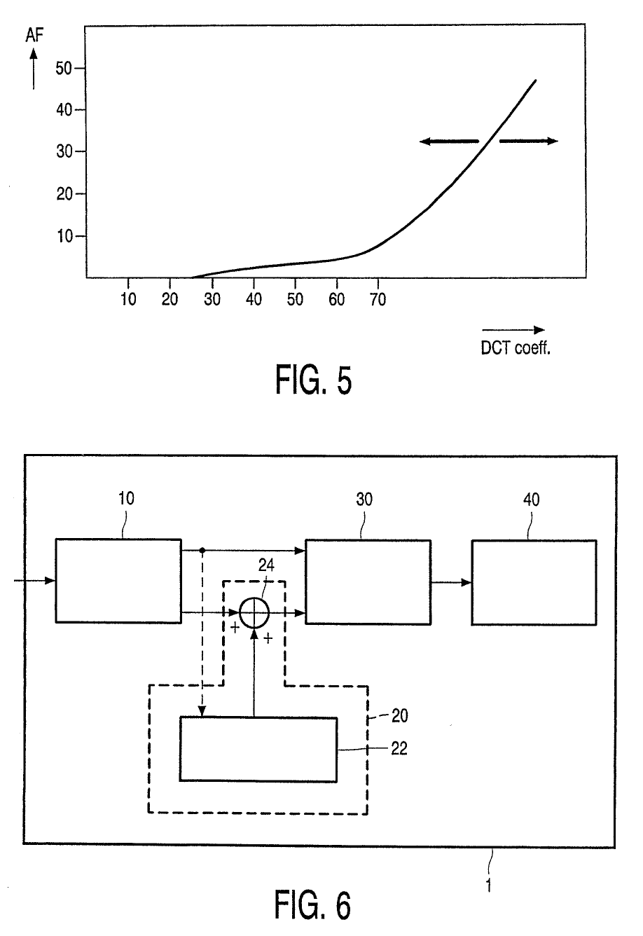

FIG. 5 is a bit rate reduction curve utilisable in conjunction with the embodiment of FIG. 4 for damping of high order DCT coefficients; and

FIG. 6 shows a digital recording apparatus according to an embodiment of the invention.

Any digital recording apparatus that can record an analogue signal by encoding of the analogue signal into digital format and which can then playback the encoded video signal includes a transcoding system. The combined actions of reformatting and adapting the bit rate of an incoming digital video signal to a value/format suitable for a given storage medium amount to transcoding. A simple method for realising a transcoder is to use a cascaded decoder and encoder. A number of known digital recording apparatuses for video applications comprise a cascaded decoder and an encoder, and transcoding schemes using this arrangement confer advantages in that filtering and other operations can be carried out on the video signal in the pixel domain. Such operations can improve image quality.

A first embodiment of the present invention incorporates a watermark embedding system with cascaded decoder/encoder transcoders of the type commonly found in digital recording apparatuses.

Referring now to FIG. 1a, there is shown a first part of a transcoder which comprises a decoder 10, a watermark embedder 20 and a second part of the transcoder which comprises an encoder 30. The watermark embedder 20 comprises a watermark generator 22 and an adder 24. That is, a watermark pattern, for instance generated “on the fly” by a pseudo random noise generator or alternatively read out from a memory, is combined with luminance values of pixels in the image, video, or to samples of the audio content. An input data stream is fed to the decoder 10. The first output of the decoder 10 comprises coding parameters and is fed to a first input of the encoder 30. A second output of the decoder 10 comprises a baseband video signal and is passed to a first input of the adder 24. An output of the watermark generator 22 is fed to a second input of the adder 24. An output of the adder 24 is fed to a second input of the encoder 30. The output of the encoder 30 comprises the information to be recorded in a format compatible with a storage medium.

The input data stream is in a first format and may be received by the decoder 10 from a source of digital information external to the digital recording apparatus, or, some initial processing such as demodulation, automatic gain control or other processing may be performed on the incoming data stream by other systems within the digital recording apparatus. The output of the encoder 30 which is in a second format determined by the encoding scheme of the encoder and suitable for the eventual storage medium may be fed directly to a storage medium—it will be appreciated however that some further processing may be applied to the output of the encoder 30 if desired.

Typically, the input to the decoder 10 comprises an MPEG-2 TS format, and the output of the encoder 30 comprises an MPEG-2 PS format. The generation of a baseband video signal by the decoder 10 allows the watermark embedder 20 to embed a watermark which is not restricted by the need to maintain the syntax of the input format or any other coding scheme.

Alternatively, the first format and second formats may be identical, but apply different compression parameters. For instance, the first format may be a Transport Stream (TS) format and the second format may also be a Transport stream, however, one which uses a different (usually lower) bit rate to compress the video (more aggressively). In this case the transcoding operation is one which (partially) interprets the video and removes less essential data. Such an operation for instance requantization, lends itself very well to be combined with the addition of a watermark.

The adder 24 combines the watermark information supplied to its second input from the output of the watermark generator 22 and the video signal supplied to its first input by the decoder 10.

The dashed line (----) shown in FIG. 1a represents an optional connection which in certain embodiments may be provided. This optional connection allows certain coding parameters to be fed to the watermark embedder 20 from the first output of the decoder 10. These parameters are interpreted by the watermark generator 22 and can be used to make the watermark embedding process locally adaptive to adapt to the received “host” video, and may allow some analysis of the video so that the watermark may be embedded with an appropriate strength—possibly dependent on a watermark already present in the incoming data stream and detected by a watermark detector/interpreter (not shown).

Adaptively controlling the strength of insertion may be achieved by means of, for example, including a multiplier (not shown) at the output of the watermark generator 22 for multiplying that output by an adaptive amplification factor prior to passing the multiplied result to the adder 24. Another implementation is to replace the adder by a multiplier (in such a case the watermark generator would not generate numbers close to 0, but numbers close to 1).

The process of embedding a watermark, in many implementations can be interpreted simply as the “mixing in” of a pseudo-random noise signal. The power of the noise signal is chosen such that it can not easily be detected by a human observer. To ensure imperceptibility, the parameter of the power of the embedded signal preferably is adapted to the local and temporal masking properties of the content. In practice the estimation, (i.e., calculation of the masking properties) can be a complicated task. However, one can retrieve the information about masking properties by reading parameters, such as the picture-type, the quantization step size, and quantization matrix, used by the compression algorithm from the incoming stream of the first format. This is indicated by the dotted line. As a matter of fact, during lossy compression, the encoder already has executed an analysis of the content to determine which parts require an accurate representation and which parts allow a relatively inaccurate representation, based on a perceptual model of the error masking properties. The encoder exploits this to effectively compress the video. That is, masking information is implicitly carried by the stream of format 1 because the syntax of the stream describes how certain parts have been compressed more aggressively, tolerating larger (yet imperceptible) errors than other parts. The watermark embedder can exploit this, by embedding the watermark stronger in parts where it learns (through the “side” information over the dotted line in FIG. 1) that the encoder (after analysis of the perceptual properties of the content) accepted relatively large errors in the content.

FIGS. 1b and 1c show alternate arrangements of watermark embedder 20′ and 20″ respectively. In FIGS. 1b and 1c, the watermark embedders 20′, 20″ are adaptive embedders for varying the strength of embedding as described above. The strength of embedding is governed by the extent to which a change of pixel values is allowed to be visually apparent. The information needed to determine such appropriate strength is carried by the information stream in two places: (i) header information (for example picture type, quantization matrix etc., and (ii) the values of the coding coefficients (for example DCT coefficents) themselves.

Referring to FIG. 1b in detail, it can be seen that the same generalised elements as shown in FIG. 1a are present and comprise decoder 10, watermark embedder 20′ and encoder 30. Here, the watermark embedder 20′ comprises a watermark generator 22′, an adder 24′, a first multiplier 25′, a filter 26′ and a second multiplier 27′. The watermark generator 22′ receives parametric information (i) from the decoder 10 and outputs an adaptive watermark signal to a first input of the second multiplier 27′. The filter 26 receives decoded coefficients (ii) from the decoder 10 and filters those coefficients to output a filtered version to a second input of the second multiplier 27′. The second multiplier 27′ multiplies the adaptive watermark information by the filtered coeffcients and provides the product to the first input of the first multiplier 25′. A second input of the first multiplier 25′ receives a signal λ which reflects a global or generalised strength of embedding of the watermark. The product of the first and second inputs of the first multiplier 25′ is then output to the first input of the adder 24′. A second input of the adder 24′ is connected to the decoded coefficient output of the decoder 10 and the adder 24′ presents, at its output, the coefficient stream with embedded watermark information to an input of the encoder 30.

From the description above of the FIG. 1b embodiment, it can be seen that the watermark embedder 20′ ensures that the watermark is embedded to a particular strength which is governed by a generalised global strength setting and by a variable strength setting determined by parameters (i) decoded from the decoder 10. Mathematically, if the particular filter characteristic of the filter 26′ is for the moment disregarded, the output of the adder 24′ is: DCT+(DCT.W.λ)=DCT (1+Wλ). In this equation, W is the adaptive output of the watermark generator 22′, DCT represents the coefficients output from the decoder 10 and λ is the global strength embedding setting. So here, it can be seen that the watermark is inserted by multiplying the coefficients output from the decoder by a factor of (1+Wλ).

Referring now specifically to FIG. 1c, the watermark embedder 20″ comprises watermark generator 22″, adder 24″ and first multiplier 25″. The watermark generator 22″ receives both parameters (i) and coefficients (ii) from the decoder 10 and outputs an adaptive watermark to a first input of the first multiplier 25″. A second input of the first multiplier receives the global embedding factor λ and the first multiplier 25″ outputs the product of the first and second inputs to a first input of the adder 24″. A second input of the adder 24″ comprises the coefficients from the decoder 10. The sum of the first and second inputs of the adder 24″ is output to an input of the encoder 30.

As will be appreciated from the above, there are various different ways of combining a watermark signal with coefficients from a decoder 10 and, although in the further embodiments of the invention described hereinafter only one particular way is mentioned (i.e. adding the watermark to the coefficients), it will be appreciated that the scope of the present invention encompasses all the various applicable ways of incorporating watermark information into the coefficient stream.

Whilst adaptive watermarking has been discussed above, it is also appreciated that the optional connection between the first output of the decoder 10 and the watermark embedder 20 may be omitted and thus the structure of the watermark embedder 20 may be simplified at the cost of either losing the adaptive nature of the watermark embedding process, or of having to perform a perceptual analysis as an additional task inside the embedder 20.

Although the decoder 10, watermark embedder 20, and encoder 30 are shown as separate entities, it will be appreciated that these entities may be combined on, for instance, a single chip. Combining in this way has security advantages in that tampering with the watermark generator 22 (or extracting the secrets of the watermark pattern) is made more difficult.

A second embodiment of the invention incorporates a watermark embedding system with a motion compensated bit rate transcoder (MC-BRT). The MC-BRT takes advantage of the reciprocity of decoding/encoding to provide a simplified transcoder architecture over the cascaded decoder/encoder.

Referring now to FIG. 2, there is shown a variable length decoder (hereinafter “VLD”) 50, a first dequantisation circuit (hereinafter “DQ1”) 52, a first subtractor 54, a quantisation circuit (hereinafter “Q1”) 56, a variable length coder (hereinafter “VLC”) 58, a second dequantisation circuit (hereinafter “DQ2”) 61, a second subtractor 62, an inverse discrete cosine transform circuit (hereinafter “IDCT”) 63, a picture memory (hereinafter “MEM”) 64, a motion compensation circuit (hereinafter “MC”) 65, a discrete cosine transform circuit (hereinafter “DCT”) 66 and a watermark embedder 70. The DQ2 61, second subtracter 62, IDCT 63, MEM 64, MC 65 and DCT 66 form component parts of an error compensation circuit (hereinafter “ECC”) 60. The VLD 50, DQ1 52, first subtractor 54, Q1 56, VLC 58, and ECC 60 in isolation form a conventional bit-rate transcoder motion compensater. The watermark embedder 70 comprises an adder 74 and a watermark generator 72.

In simple terms, the watermark embedder 70 receives first data from a first part (here VLD 50, DQ1 52 and first subtractor 54) of the transcoder and outputs data to a second part (Q1 56, VLC 58).

More specifically, an input data stream of first format is fed to the VLD 50. A first output of the VLD 50 comprising variable length decoded quantization coefficients is fed to the DQ1 52. A second output of the VLD 50, comprising motion vectors, headers etc. is fed to a first input of the VLC 58. Motion vectors from the second output of the VLD 50 are fed to a first input of the MC 65 of the error compensation circuit 60. De-quantized variable length decoded coefficients from an output of DQ1 52 are fed to a first input of the first subtractor 54. The first subtractor 54 has a second input which receives error compensation coefficients in a conventional manner from DCT 66 of the ECC 60. An output of the first subtractor 54 comprises the difference between its first and second inputs. The output of the first subtractor 54 is fed to a first input of the second subtractor 62 of the ECC 60 and to a first input of the adder 74 of the watermark embedder 70.

An output of the watermark generator 72 of the watermark embedder 70 is fed to second input of the adder 74. An output of the adder 74 which comprises the sum of its first and second inputs is fed to a first input of Q1 56. A second input of Q1 56 receives bit rate control information. An output of Q1 56 which comprises requantized coefficients now containing the additional watermark is fed to a second input of the VLC 58. A first output of the VLC 58 comprises the bit rate control information which is fed back to the second input of the Q 56. A second output of the VLC 58 comprises the variable length coded and quantized information (now containing embedded watermark information) to be recorded, in the second format which is compatible with a given storage medium.

The output of Q1 56 is fed to an input of DQ2 61 of the ECC 60. An output of DQ2 61 comprising dequantized coefficients is fed to a second input of the second subtractor 62. The output of the second subtractor comprises the difference between the output of DQ2 61 and the output of the first subtractor 54. The output of the second subtractor 62 is fed to IDCT 63. The output of the IDCT 63 is fed to the MEM 64. The output of the MEM 64 is fed to a second input of the MC 65. An output of the MC 65 is fed to the DCT 66. The output of the DCT 66 is fed to the second input of the first subtractor 54, thus completing the error compensation feedback loop.

The input data stream received by the VLD 50 and the output of the VLC 58 have similar characteristics to those described in relation to the input data stream and the output of the first embodiment. As previously mentioned, the circuit architecture of the embodiment of FIG. 2 is completely conventional apart from the addition of the watermark embedder 70 and therefore, the operation of, the transcoder per se will be well known to the man skilled in the art.

In this embodiment the watermark is added to the video information in the discrete cosine transform domain, thus maintaining the flexibility afforded by not adding the watermark in the MPEG coding scheme of the final output. The complexity of this scheme is less than that required for carrying out the full decoding/encoding of the first embodiment.

In general, motion compensation and motion prediction can cause patches of a watermark to be replicated in a way that is not intended, for example multiple, mutually shifted copies of the watermark may appear in video data. This may be detrimental to the detection of the intended watermark. To help avoid possible unwanted replication of a watermark, in the embodiment of FIG. 2, the output of the watermark generator 72 is added to the video data in the discrete cosine transform domain by the adder 74 within the forward path of the error compensation feedback loop.

Further alternatives to the configuration shown in FIG. 2 are to place the adder 74 immediately after the DQ1 52, or immediately after the Q1 56. All such choices still benefit from the advantage of reduced complexity by avoiding the need for full duplication of decoders/encoders.

The second embodiment of the invention as shown in FIG. 2 may be made locally adaptive by feeding coding parameters extracted from the VLD 50 to the watermark generator 72 in similar fashion to the optional connection of the FIG. 1 embodiment. In this regard, the watermark generator 72 may include an internal or external multiplier for varying the strength of application of the watermark in the adaptive manner suggested in relation to the first embodiment. The watermark generator 72 may also receive side information, e.g. picture type, quantization step sizes or the quantization matrix, from the Q1 56.

A third embodiment of the invention shown in FIG. 3 incorporates a watermark embedding system with a discrete cosine transform coefficient requantisation bit rate transcoder (BRT). The BRT is a simplification of the MC-BRT of the second embodiment in which the error compensating feedback loop of ECC 60 is omitted. The BRT takes advantage of the reciprocity of decoding/encoding to provide a simplified transcoder architecture over the cascaded decoder/encoder and at the cost of possible accumulation of requantisation errors a considerable simplification over the MC-BRT.

Referring now to FIG. 3 in more detail there is shown a VLD 50, a DQ1 52, a watermark embedder 70, a Q1 56 and a VLC 58. The watermark embedder 70 comprises an adder 74 and watermark generator 72 in similar fashion to the FIG. 2 embodiment. The signal flow from the input of the VLD 50 to the output of the VLC 58 is identical to that of the second embodiment except for the omission here of the ECC 60.

It will be understood by the man skilled in the art that the circuitry of the FIG. 3 embodiment is entirely conventional apart from the addition of the watermark generator between DQ1 52 and QI 56.

The dashed line (----) represents an optional connection between VLD 50 and watermark generator 72 for rendering the watermark embedder 70 locally adaptive in a similar fashion to the first embodiment. For instance, I, B and P frames may be treated differently to mitigate propagation of errors/artifacts.

A fourth embodiment of the invention incorporates a watermark embedding system within a discrete cosine transformation coefficient damping transcoder (BRT′). The BRT′ is very similar to the BRT as can be seen by comparing FIG. 4 with FIG. 3.

FIG. 4 shows a VLD 50, a DQ1 52, a watermark embedder 70, a Q1 56 and a VLC 58. Again, the watermark embedder comprises a watermark generator 72 and an adder 74. The difference between the embodiments shown in FIG. 3 and FIG. 4 is in the operation of Q1 56. In the BRT′, Q1 56 does not requantise all the discrete cosine transform coefficients, instead it damps the higher order coefficients. DQ1 52 and Q1 56 are controlled by the bit rate. As the desired eventual output has a lower bit rate (i.e. format 1 has a higher bit rate than format 2), the output has larger quantization steps. The degree to which this quantization step matches the bit-rate is measured at the output of the VLC 58 which in turn controls the bit rate.

Damping of high-order coefficients means that the transcoder not only changes the quantization scale to decrease the bit rate, but it also attenuates high DCT-components to avoid annoying drift problems.

FIG. 5 shows a characteristic which Q1 56 may apply to the DCT coefficients in order to provide such high order damping and thereby reduce the bit rate.

The Figure displays the attenuation damping factor AF of a particular DCT coefficient as a function of the position of a DCT zig-zag scan (DCT coeff.). In other words, the higher the frequency in this case (and thus the higher the position in the zig-zag), the stronger the attenuation to be applied. The attenuation is never 100%, so even the highest frequency DCT coefficients are never attenuated all the way to zero.

By applying this curve in the watermark generator 72 the coding artefacts, i.e., error accumulations, are perceptually less visible. The error accumulation becomes perceptually visible in requantization algorithms without feedback loop due to the fact that the low frequency DCT coefficients are affected.

The embodiments described above provide apparatuses suitable for use in domestic digital recording equipment incorporating watermark embedding systems that do not require the introduction of additional complex decompression and recompression systems.

The latter three methods of bit rate transcoding mentioned are mutually not exclusive, so this means that hybrid solutions can be made as well.

FIG. 6 shows a digital recording apparatus 1 according to an embodiment of the invention, such as a Personal Video Recorder or Set Top Box. The digital recording apparatus 1 comprises an arrangement according to FIG. 1a for transcoding and watermark embedding. The arrangement further comprises a recorder 40 for storing the signal obtained from the encoder 30 on a storage medium, such as a hard disc, a tape, a compact disc, Digital Versatile Disc (DVD), etc. The recorder 40 is a suitable recorder, such as a hard disc drive, a tape recorder, a compact disc recorder, a DVD recorder, etc. Instead of the arrangement of FIG. 1a, the digital recording apparatus may also comprise an embodiment acording to one of the other FIGS. 1b, 1c, 2, 3 or 4.

This document discloses the principle of merging transcoding and watermark insertion. This reduces complexity and can mitigate visual artifacts. Various examples of implementations have been given, but the scope is not limited thereto—rather, the scope of the invention is limited solely by the accompanying claims.

Although the text focuses on video, the concept also applies to audio. We further notice that in the process of watermark embedding, perceptual masking information (if generated and used by the transcoder) can advantageously be used by the watermark embedder. This will occur predominantly in audio applications. It is likely to be useful in video as well.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. An apparatus comprising: a transcoder for converting an input data stream containing information in a first format into a second format; and a watermark embedding device for embedding a watermark within an output data stream, the apparatus being characterised in that the watermark embedding device is arranged to receive first data from a first part of the transcoder and to provide watermarked data to a second part of the transcoder.

2. The apparatus of claim 1, wherein the first part of the transcoder comprises decoding means for at least partially decoding the input data stream containing information in the first format.

3. The apparatus of claim 1, wherein the second part of the transcoder comprises encoding means for converting to the second format.

4. The apparatus of claim 1, wherein the transcoder comprises a cascaded decoder and encoder.

5. The apparatus of claim 1, wherein the transcoder comprises a motion compensated bit rate transcoder.

6. The apparatus of claim 1, wherein the transcoder comprises a discrete cosine transform coefficient requantization bit rate transcoder.

7. The apparatus of claim 1, wherein the transcoder comprises a discrete cosine transform coefficient damping bit rate transcoder.

8. The apparatus of claim 1, wherein the second format is a format compatible with a storage medium on which the information is to be stored.

9. The apparatus of claim 1, wherein the first and second formats are identical, apart from having different compression characteristics.

10. The apparatus of claim 1, wherein coding parameters from the input data stream are utilised to adapt the watermark to the content in which it is to be embedded.

11. Digital recording apparatus comprising the apparatus of claim 1 and means for recording the output data stream on a storage medium.

12. A method of embedding a watermark within information of a received data stream, the method comprising:
receiving an input data stream containing information in a first format and decoding data from said first format to provide decoded data;
embedding the watermark into the decoded data to provide decoded watermarked data; and
encoding the decoded watermarked data into a second format.
